(19) United States
(12) Patent Application Publication
(10) Pub. No.: US 2025/0045345 A1
(43) Pub. Date: Feb. 6, 2025

(54) OPTIMIZATION DEVICE, OPTIMIZATION METHOD AND OPTIMIZATION PROGRAM

(71) Applicant: NEC Corporation, Tokyo (JP)

(72) Inventor: Akio TODA, Tokyo (JP)

(73) Assignee: NEC Corporation, Tokyo (JP)

(21) Appl. No.: 18/787,140

(22) Filed: Jul. 29, 2024

(30) Foreign Application Priority Data
Aug. 3, 2023 (JP) 2023-126778

(51) Int. Cl. G06F 17/11

(52) U.S. Cl. CPC G06F 17/11

(57) ABSTRACT

The optimization device includes an annealing means. The annealing means executes solution calculation so as to exclude from search range spin sets whose distances from the spin sets indicating optimal solutions obtained by the n−1st solution calculation are within a predetermined range in the nth solution calculation.

### CROSS-REFERENCE TO RELATED APPLICATIONS

This application is based upon and claims the benefit of priority from the prior Japanese Patent Application No. 2023-126778, filed Aug. 3, 2023, the entire contents of which are incorporated herein by reference.

### BACKGROUND OF THE INVENTION

This disclosure relates to an optimization device, an optimization method, and an optimization program that solves a combinatorial optimization problem by annealing.

In general, quantum annealing is used to solve a combinatorial optimization problem. For example, Patent Literature 1 describes an information processing device for constructing a regression model. In the information processing device described in Patent Literature 1, an optimal solution calculation unit obtains an optimal solution from the regression model using quantum annealing.

Non-patent Literature 1 describes a method of using quantum annealing for a black box optimization problem as a method for determining arrangement of material that provide desired radiation intensity of radiative cooling material.
[Patent Literature 1] Japanese Laid-Open Patent Publication No. 2022-003484
[Non-patent Literature 1] Koki Kitai, et. al., “Designing metamaterials with quantum annealing and factorization machines”, PHYSICAL REVIEW RESEARCH 2, 013319 (2020)

### SUMMARY OF THE INVENTION

On the other hand, depending on application, not only an optimal solution that gives an optimal value of an objective function, but also a stepwise optimal solution such as a second optimal solution and a third optimal solution may be required. However, it is generally difficult to obtain such stepwise optimal solutions.

Therefore, the purpose of this disclosure is to provide an optimization device, an optimization method, and an optimization program by which stepwise optimal solutions in optimization using annealing can be obtained.

An optimization device according to the present disclosure is an optimization device that solves a combinatorial optimization problem by annealing, and includes an annealing means which executes solution calculation by annealing multiple times, wherein the annealing means executes solution calculation so as to exclude from search range spin sets whose distances from the spin sets indicating optimal solutions obtained by the n−1st solution calculation are within a predetermined range in the nth solution calculation. Another optimization device according to the present disclosure is an optimization device that solves a combinatorial optimization problem by annealing, and includes an annealing means which executes solution calculation by annealing multiple times, and a learning means which learns an objective function model expressed by a spin polynomial by machine learning using training data which includes pairs of a spin set as an explanatory variable and a value obtained by applying the spin set to a black box function representing a black box optimization problem as an objective variable, wherein the annealing means executes the solution calculation by the annealing using a Hamiltonian including the objective function model, and executes multiple optimization calculations in which learning of the objective function model and the solution calculation by the annealing are repeated, and the annealing means executes solution calculation by the annealing so as to exclude from search range spin sets whose distances from spin sets indicating best solutions obtained by the n−1st optimization calculation are within a predetermined range in the nth optimization calculation.

An optimization method according to the present disclosure is an optimization method that solves a combinatorial optimization problem by annealing, and includes executing solution calculation by annealing multiple times, wherein in the annealing, executing solution calculation so as to exclude from search range spin sets whose distances from the spin sets indicating optimal solutions obtained by the n−1st solution calculation are within a predetermined range in the nth solution calculation. Another optimization method according to the present disclosure is an optimization method that solves a combinatorial optimization problem by annealing, and includes: learning an objective function model expressed by a spin polynomial by machine learning using training data which includes pairs of a spin set as an explanatory variable and a value obtained by applying the spin set to a black box function representing a black box optimization problem as an objective variable; executing solution calculation by the annealing using the objective function including the objective function model; executing multiple optimization calculations in which learning of the objective function model and the solution calculation by the annealing are repeated; and executing solution calculation by the annealing so as to exclude from search range spin sets whose distances from spin sets indicating best solutions obtained by the n−1st optimization calculation are within a predetermined range in the nth optimization calculation.

An optimization program according to the present disclosure is an optimization program applied to a computer that solves a combinatorial optimization problem by annealing, causing the computer to execute an annealing process for executing solution calculation by annealing multiple times, wherein the optimization program causes the computer to execute solution calculation so as to exclude from search range spin sets whose distances from the spin sets indicating optimal solutions obtained by the n−1st solution calculation are within a predetermined range in the nth solution calculation, in the annealing process. Another optimization program according to the present disclosure is an optimization program applied to a computer that solves a combinatorial optimization problem by annealing, causing the computer to execute an annealing process for executing solution calculation by annealing multiple times, and a learning process for learning an objective function model expressed by a spin polynomial by machine learning using training data which includes pairs of a spin set as an explanatory variable and a value obtained by applying the spin set to a black box function representing a black box optimization problem as an objective variable, wherein the optimization program causes the computer to execute the solution calculation by the annealing using an objective function including the objective function model, in the annealing process, and execute multiple optimization calculations in which learning of the objective function model and the solution calculation by the annealing are repeated, and the optimization program execute solution calculation by the annealing so as to exclude from search range spin sets whose distances from spin sets indicating best solutions obtained by the n−1st optimization calculation are within a predetermined range in the nth optimization calculation, in the annealing process.

According to this disclosure, it is possible to obtain stepwise optimal solutions in optimization using annealing.

### BRIEF DESCRIPTION OF DRAWINGS

FIG. 1 is a block diagram showing a configuration example of the first example embodiment of an optimization device according to this disclosure.

FIG. 2 is an explanatory diagram showing an example of optimization process.

FIG. 3 is a flowchart showing an example of an operation of the optimization device according to this disclosure.

FIG. 4 is a flowchart showing an example of an operation of the first solution calculation by annealing.

FIG. 5 is a flowchart showing an example of an operation of the nth solution calculation by annealing.

FIG. 6 is a flowchart showing another example of an operation of the nth solution calculation by annealing.

FIG. 7 is a block diagram showing a configuration example of the second example embodiment of an optimization device according to this disclosure.

FIG. 8 is an explanatory diagram showing an example of optimization calculation.

FIG. 9 is an explanatory diagram showing an example of a graph showing convergence status of an objective function.

FIG. 10 is a flowchart showing an example of an operation of the optimization device according to this disclosure.

FIG. 11 is a flowchart showing an example of an operation of the first optimization calculation.

FIG. 12 is a flowchart showing an example of an operation of the nth optimization calculation.

FIG. 13 is a flowchart showing another example of an operation of the nth optimization calculation.

FIG. 14 is a block diagram showing an outline of the optimization device according to this disclosure.

FIG. 15 is a block diagram showing another outline of the optimization device according to this disclosure.

FIG. 16 is a schematic block diagram showing a configuration of a computer according to at least one example embodiment.

### DETAILED DESCRIPTION OF THE INVENTION

Hereinafter, an example embodiment of this disclosure will be explained with reference to the drawings.

### Example Embodiment 1

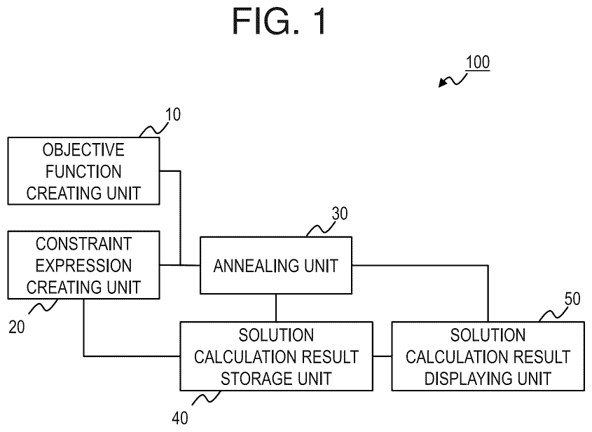

FIG. 1 is a block diagram showing a configuration example of the first example embodiment of an optimization device according to this disclosure. The optimization device 100 in this example embodiment includes an objective function creating unit 10, a constraint expression creating unit 20, an annealing unit 30, a solution calculation result storage unit 40, and a solution calculation result displaying unit 50.

The objective function creating unit 10 creates an objective function of a combinatorial optimization problem. The content of the combinatorial optimization problem is arbitrary, and the method of creating the objective function is also arbitrary. The objective function creating unit 10 may create an objective function expressed in a general mathematical formula, or may create an objective function in the form (e.g., spin polynomial) used by the annealing unit 30 to perform optimization, as described below. The objective function creating unit 10 may also accept input of an objective function created by a user or other person.

The constraint expression creating unit 20 creates constraint expressions that express the constraint conditions imposed on the combinatorial optimization problem. The contents of the constraint conditions are arbitrary, and the method of creating constraint expressions is also arbitrary. The constraint expression creating unit 20 may create constraint expressions expressed in general mathematical formulae, or may create constraint expressions in the form (e.g., spin polynomial) used by the annealing unit 30 to perform optimization, as described below. The constraint expression creating unit 20 may also accept input of constraint expressions created by a user, etc.

The constraint expression creating unit 20 may also create a new constraint expression according to an instruction from the annealing unit 30 described below. The content of the new constraint expression to be created will be described later. The processes of the objective function creating unit 10 and the constraint expression creating unit 20 may also be executed by the annealing unit 30.

The annealing unit 30 executes solution calculation by annealing. The annealing unit 30 in this example embodiment executes solution calculation by annealing multiple times. Although the example shown in FIG. 1 shows a configuration in which the annealing unit 30 is realized together with the optimization device 100, the annealing unit 30 may cause a quantum annealing machine (not shown), which is realized in a device different from the optimization device 100, to execute solution calculation by annealing. In other words, the annealing unit 30 may perform the optimization process by annealing by itself, or may cause a quantum annealing machine (not shown) to execute the optimization process.

The quantum annealing machine described above is, for example, a device that solves the target optimization problem by an annealing method. The quantum annealing machine is a dedicated device for obtaining the ground state of the Hamiltonian of the Ising model, and is realized as a device that performs annealing in response to the instructions of the annealing unit 30. More specifically, the quantum annealing machine is a device that probabilistically determines the value of a binary variable that minimizes or maximizes the Hamiltonian of the Ising model with the binary variable as an argument.

The binary variable may be realized in classical or quantum bits. The form of the annealing unit 30 and the quantum annealing machine is arbitrary, in this example embodiment. The annealing unit 30 and the quantum annealing machine may be configured with any hardware that probabilistically determines the value of the binary variable that minimizes or maximizes the Hamiltonian with the binary variable as an argument. The annealing unit 30 and the quantum annealing machine may be, for example, a non-von Neumann architecture in which the Hamiltonian is implemented by hardware in the form of an Ising model, or a device using pseudo-quantum annealing technology or quantum inspired technology.

In the following description, it is stated that the annealing unit 30 executes the solution calculation by annealing both when the annealing unit 30 itself executes the optimization process by annealing and when the annealing unit 30 cause a quantum annealing machine (not shown) to execute the optimization process.

Furthermore, the annealing unit 30 in this example embodiment executes the calculation to find the optimal solution so as to exclude the optimal solutions already obtained in the past solution calculation. In the following description, the solution obtained as a result of this calculation to find the optimal solution so as to exclude the optimal solutions already obtained in the past solution calculation is also referred to as the optimal solution. Specifically, in the nth (n≥2) solution calculation, the annealing unit 30 executes solution calculation so as to exclude from search range spin sets whose distances from the spin sets indicating the optimal solutions obtained by the n−1st solution calculation are within a predetermined range. The content of the distance between spin sets to be used in the determination is predetermined by the user, etc.

The annealing unit 30 may use the Hamming distance between spin sets as the distance between spin sets. Otherwise, the annealing unit 30 may use the distance between sets of decision variables represented by spins (e.g., Euclidean distance) as the distance between spin sets.

The following is a specific example of representing decision variables by spins. For example, the decision variable u, which can take values from 0 to 127, can be expressed as shown in Equation 1 in the example below, with the binary number 2ⁱ places expressed in spin, using the spin set s=[s₀, s₁, s₂, s₃, s₄, s₅, s₆], sᵢ∈{0, 1}.

$$[ Math . 1 ]$$

$$u = {\sum }_{i = 0}^{6} {2}^{i} {s}_{i} \qquad ( Equation 1 )$$

The above decision variable u can also be expressed as in Equation 2, shown below, using the one-hot condition.

$$[ Math . 2 ]$$

$$u = {\sum }_{i = 0}^{127} i {s}_{i} \qquad ( Equation 2 )$$

However, in the expression method shown in Equation 2, the required spin sets are s=[s₀, s₁, s₂, . . . , s₁₂₇], and to impose the one-hot condition, the constraint expression shown in Equation 3 below must be added to the Hamiltonian.

$$[ Math . 3 ]$$

$${( {\sum }_{i = 0}^{127} {s}_{i} - 1 )}^{2} \qquad ( Equation 3 )$$

In the following explanation, to simplify the explanation, the case in which the Hamming distance between spin sets is used as the distance is described. However, the same applies when the distance between the decision variables (Euclidean distance, etc.) is used.

The predetermined range used to make the decision can also be predetermined by the user, etc. For example, when excluding solutions with up to two different spin values from optimal solutions, the Hamming distance d=3 may be set.

The following describes specific methods of executing the solution calculation so as to exclude from search range spin sets whose distances from spin sets indicating the optimal solutions obtained in the past solution calculations are within a predetermined range. The first method is to add a constraint expression that gives a (positive) penalty if a solution whose distances from the spin sets indicating the optimal solutions already obtained in the past solution calculations are within a predetermined range is selected.

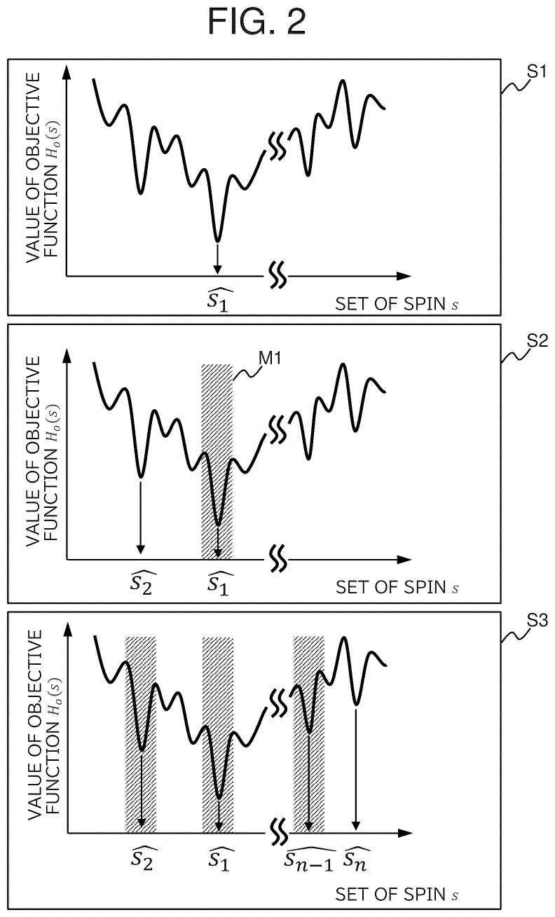

FIG. 2 is an explanatory diagram showing an example of optimization process. Here, it is assumed that the objective function H_{O}(s) is created by the objective function creating unit 10 and the constraint expression H_{C} (s) is created by the constraint expression creating unit 20, resulting in the generation of a Hamiltonian H=H_{O}(s)+H_{C}(s).

The annealing unit 30 executes the first solution calculation by annealing (step S1). The first solution calculation gives a spin set “s₁ superscript hat” (hereinafter, “superscript hat” is denoted by \hat{ }:s₁\hat{ })=[s_{1,1}\hat{ }, s_{1,2}\hat{ }, s_{1,3}\hat{ }, . . . , s_{1,Ns}\hat{ }] that minimizes the objective function (Hamiltonian H).

Next, the annealing unit 30 executes a second solution calculation using a Hamiltonian with an additional constraint expression H_{C}′(s), that gives a penalty if a solution whose distance from the spin set indicating the optimal solution already obtained in the first solution calculation is within a predetermined range is selected (step S2). The constraint expression H_{C}′(s) is expressed, for example, by Equation 4, which is shown below.

$$[ Math . 4 ]$$

$${{H}_{c}}^{′} ( s ) = {\{ {\sum }_{i = 1}^{{N}_{s}} {( {s}_{i} − \hat{{s}_{1 , l}} )}^{2} − ( d + {\sum }_{i = 0}^{⌈ {log}_{2} ( {N}_{s} − d + 1 ) ⌉ − 1} {2}^{i} {y}_{i} ) \}}^{2} \qquad ( Equation 4 )$$

The first term in parentheses in Equation 4 represents the Hamming distance between s₁\hat{ } and s, it takes the value 0 when s₁\hat{ }=s and the value 1 to Nₛ when s₁\hat{ }≠s. The second term in parentheses in Equation 4 is a slack variable containing an integer between d and Nₛ and is expressed here using binary numbers.

The Hamiltonian H=H_{O}(s)+H_{C}(s)+H_{C}′(s) with the added constraint expression shown in Equation 4 above causes a penalty to be imposed if a combination of spins whose distance from s₁\hat{ } is within a predetermined distance (shaded area M1 in FIG. 2) is selected, and therefore such combinations of spins are excluded from the search range in the optimization. As a result, the second solution calculation gives a different spin set s₂\hat{ }=[s_{2,1\hat{ }, s}_{2,2}\hat{ }, s_{2,3\hat{ }, s}_{2,Ns}\hat{ }] that minimize the objective function (Hamiltonian H).

In the subsequent processes, the annealing unit 30 executes the nth solution calculation using a Hamiltonian with an additional constraint expression H_{C}′(s) that gives a penalty if a solution whose distances from the spin sets indicating the optimal solutions already obtained by the n−1st solution calculation are within a predetermined range is selected (Step S3). The constraint expression H_{C}′(s) is expressed, for example, by Equation 5, which is shown below.

$$[ Math . 5 ]$$

$${{H}_{c}}^{′} ( s ) = {\sum }_{m = 1}^{n - 1} {\{ {\sum }_{i = 1}^{{N}_{s}} {( {s}_{i} − \hat{{s}_{m , l}} )}^{2} − ( d + {\sum }_{i = 0}^{⌈ {log}_{2} ( {N}_{s} − d + 1 ) ⌉ − 1} {2}^{i} {y}_{m , i} ) \}}^{2} \qquad ( Equation 5 )$$

The content of the constraint expression shown in Equation 5 is similar to the constraint expression shown in Equation 4, and imposes a penalty if a combination of spins whose distances from s₁^{\hat{ }}, s₂^{\hat{ }}, s₃^{\hat{ }}, . . . , sₙ₋₁^{\hat{ }} are within a predetermined distance is selected. As a result, the nth solution gives a different spin set sₙ^{\hat{ }}=[s_{n,1}^{\hat{ }}, s_{n,2}^{\hat{ }}, s_{n,3}^{\hat{ }}, . . . , s_{n,Ns}^{\hat{ }}] that minimize the objective function (Hamiltonian H).

The annealing unit 30 may create the constraint expression H_{C}′(s) described above by itself, or may instruct the constraint expression creating unit 20 to create the constraint expression.

Next, the second method of executing the solution calculation so as to exclude from search range spin sets whose distances from spin sets indicating the optimal solutions obtained in the past solution calculations are within a predetermined range will be described. The second method is to perform annealing so that spin sets whose distances from the spin sets indicating the optimal solutions already obtained by the past solution calculations are within a predetermined range are excluded from the search range.

The method by which the annealing unit 30 performs annealing excluding from the search range the spin sets whose distances from the spin sets indicating the optimal solutions obtained in the past solution calculations are within a predetermined range is arbitrary. For example, as a method similar to the first method, the annealing unit 30 may perform the nth solution calculation using a Hamiltonian to which a constraint expression indicating a one-hot condition has been added in order to exclude spin sets indicating optimal solutions that have already been obtained by the past n−1st solution calculation.

The method of executing the second method is not limited to adding the constraint expression. The annealing unit 30 may, for example, execute the solution calculation by instructing the quantum annealing machine that can perform annealing by excluding from the search range spin sets whose distances from spin sets indicating optimal solutions obtained in the past solution calculations are within a predetermined range to perform the optimization process. The annealing unit 30 may also execute the solution calculation by using software (annealing software) that can instruct a quantum annealing machine to exclude from the search range spin sets whose distances from the spin sets indicating optimal solutions obtained in the past solution calculations are within a predetermined range.

The second method can also perform the optimization process in the same way as the method shown in FIG. 2.

The solution calculation result storage unit 40 stores the optimal solutions obtained by multiple solution calculations. For example, the solution calculation result storage unit 40 may store the optimal solutions together with information that can identify the order in which the optimal solutions were obtained. The solution calculation result storage unit 40 is realized by, for example, a magnetic disk, etc.

The solution calculation result displaying unit 50 outputs the obtained optimal solutions. The method by which the solution calculation result displaying unit 50 outputs the optimal solution is arbitrary. For example, the solution calculation result displaying unit 50 may output the optimal solutions obtained by multiple solution calculations in the order in which they were obtained. In this example embodiment, the optimal solutions in the earlier order of the solution calculations are considered more preferable. Therefore, by the solution calculation result displaying unit 50 outputting the optimum solutions in the order in which they were obtained, it becomes possible to output the optimum solutions in order starting from the most preferable solution.

The objective function creating unit 10, the constraint expression creating unit 20, the annealing unit 30, and the solution calculation result displaying unit 50 are realized by a computer processor (e.g., CPU (Central Processing Unit), a GPU (Graphics Processing Unit)) that operates according to a program (optimization program). As described above, the annealing unit 30 may be realized by a quantum annealing machine.

For example, a program may be stored in the memory (not shown) of the optimization device 100, and the processor may read the program and operate as the objective function creating unit 10, the constraint expression creating unit 20, the annealing unit 30, and the solution calculation result displaying unit 50 according to the program. The functions of the optimization device 100 may be provided in a SaaS (Software as a Service) format.

The objective function creating unit 10, the constraint expression creating unit 20, the annealing unit 30, and the solution calculation result displaying unit 50 may each be realized by dedicated hardware. In addition, part or all of each component of each device may be realized by general-purpose or dedicated circuits (circuitry), processors, etc., or a combination of these. They may be configured by a single chip or by multiple chips connected via a bus. Part or all of each component of each device may be realized by a combination of the above-mentioned circuits, etc. and a program.

When part or all of each component of the optimization device 100 are realized by multiple information processing devices or circuits, etc., the multiple information processing devices or circuits, etc. may be centrally located or distributed. For example, the information processing devices and circuits may be realized as a client-server system, a cloud computing system, or the like, each of which is connected via a communication network.

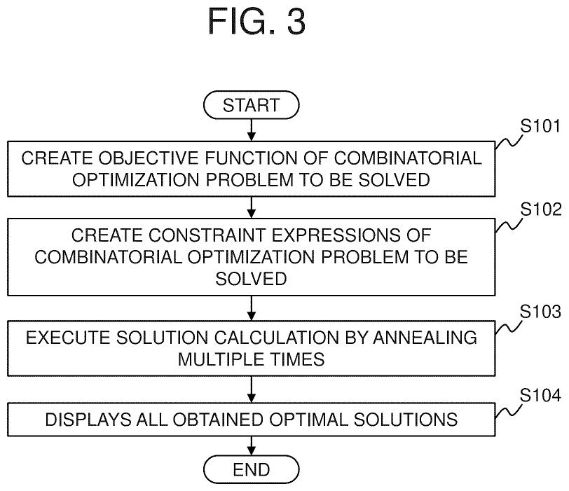

Next, the operation of the optimization device 100 will be described. FIG. 3 is a flowchart showing an example of an operation of the optimization device according to this disclosure. The objective function creating unit 10 creates an objective function expressed in polynomials of the spins of the combinatorial optimization problem to be solved (step S101). The constraint expression creating unit 20 also creates constraint expressions expressed in polynomials of the spins of the combinatorial optimization problem to be solved (step S102). The annealing unit 30 executes the solution calculation by annealing multiple times (step S103). Then, the solution calculation result displaying unit 50 displays all the obtained optimal solutions (step S104).

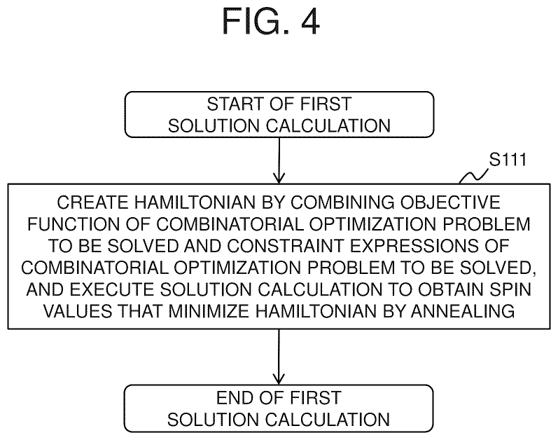

Next, the operation of the solution calculation by annealing executed multiple times (the process of step S103 shown in FIG. 3) will be described. FIG. 4 is a flowchart showing an example of an operation of the first solution calculation by annealing.

The annealing unit 30 creates a Hamiltonian by combining the objective function of the combinatorial optimization problem to be solved created in step S101 and the constraint expressions of the combinatorial optimization problem to be solved created in step S102, and executes solution calculation to obtain the spin values that minimize the Hamiltonian by annealing (step S111).

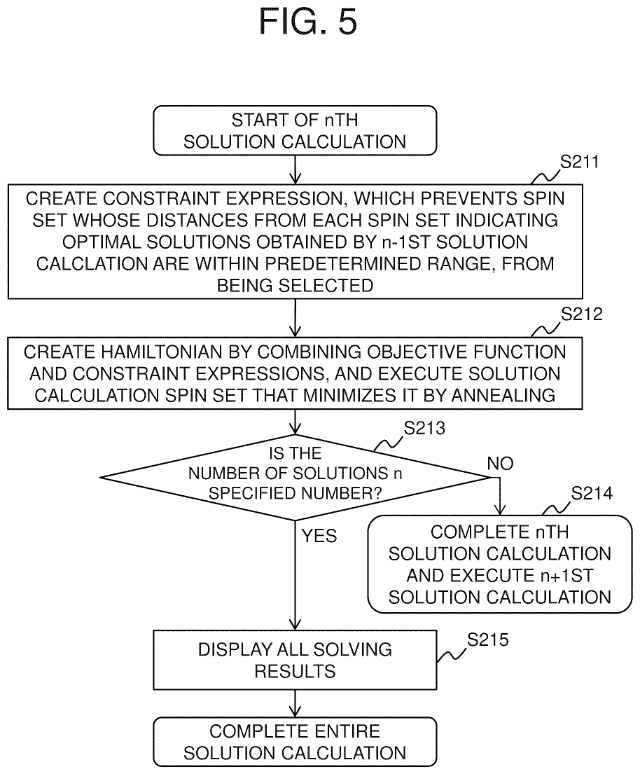

FIG. 5 is a flowchart showing an example of an operation of the nth solution calculation by annealing. The flowchart shown in FIG. 5 shows an example of the operation of a method for executing solution calculation by the first method described above.

The constraint expression creating unit 20 creates a constraint expression, expressed as a polynomial of spins, that prevents the selection of a spin set whose distances from each set of spins indicating the optimal solutions obtained by the n−1st solution calculation are within a predetermined range (step S211).

The annealing unit 30 creates a Hamiltonian by combining the objective function of the optimization problem to be solved created in step S101, the constraint expressions of the optimization problem to be solved created in step S102, and the constraint expression created in step S211, and execute solution calculation to obtain the spin set that minimizes it by annealing (step S212).

The annealing unit 30 determines whether or not the number of solution calculation times n has reached the predetermined number of times (step S213). If n has not reached the predetermined number of times (no in step S213), the annealing unit 30 completes the nth solution calculation and executes the n+1st solution calculation (step S214). On the other hand, if n has reached the predetermined number of times (yes in step S213), the solution calculation result displaying unit 50 displays all the solving results (step S215).

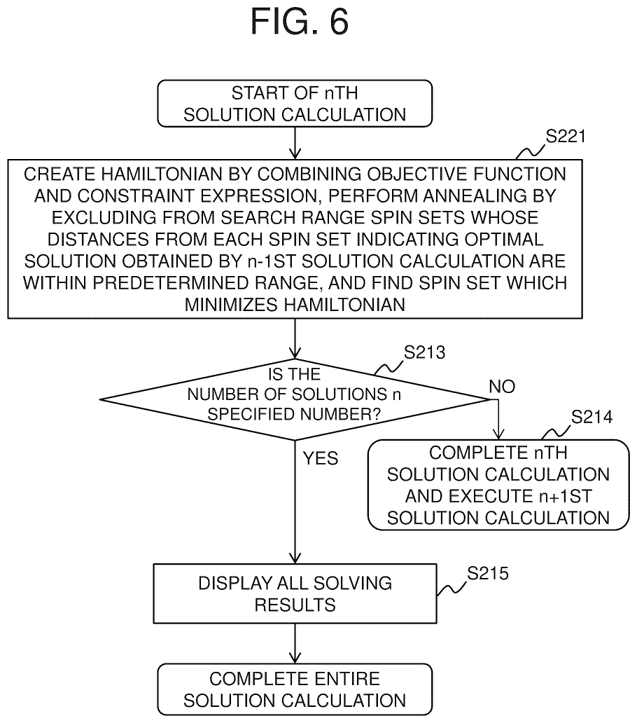

FIG. 6 is a flowchart showing another example of an operation of the nth solution calculation by annealing. The flowchart shown in FIG. 6 shows an example of the operation of a method for executing solution calculation by the second method described above.

The annealing unit 30 creates a Hamiltonian by combining the objective function of the optimization problem to be solved created in step S101 and the constraint expressions of the optimization problem to be solved created in step S102. Then, the annealing unit 30 performs annealing by excluding from the search range spin sets whose distances from each spin set indicating the optimal solutions obtained by the n−1st solution calculation are within a predetermined range, and obtains the spin set with minimum Hamiltonian (Step S221).

Thereafter, the process from determining whether or not to complete the solution calculation to displaying the solution result is similar to the process from step S213 to step S215 shown in FIG. 5.

As described above, in this example embodiment, the annealing unit 30 executes solution calculation so as to exclude from search range spin sets whose distances from the spin sets indicating the optimal solutions obtained by the n−1st solution calculation are within a predetermined range in the nth (n≥2) solution calculation. Thus, it is possible to obtain stepwise optimal solutions in optimization using annealing.

Quantum annealing is generally used to obtain the optimal value of the objective function in the combinatorial optimization problem. In contrast, in some applications, not only the optimal value of an objective function but also a ranked solution, such as the second optimal value, the third optimal value, and so on, are required.

For example, when used in material development in which various possibilities are considered, it is conceivable to proceed with development by referring not only to the raw material mixture amounts corresponding to the optimal characteristic values, but also to the raw material mixture amounts corresponding to the next-best characteristic values. This analytical method of finding the raw material mixture amounts by optimizing the characteristic values of interest is called blend amount inverse analysis. This type of blend amount inverse analysis is an example where the above-mentioned ranked solutions are required.

However, it is generally difficult to systematically find the ranked solutions using quantum annealing. On the other hand, in this example embodiment, the annealing unit 30, in the nth solution calculation, execute solution calculation so as to avoid the optimal solution obtained by the n−1st solution calculation. It is thus possible to systematically obtain ranked solutions.

### Example Embodiment 2

Next, a second example embodiment of the optimization device of the present disclosure will be described. The optimization device of the second example embodiment is assumed to solve a black box optimization problem using annealing. The black box optimization problem is an optimization problem where the expression of the objective function to be optimized is not explicitly given. Hereinafter such an objective function is referred to as the black box function. In this example embodiment, the black box optimization problem is assumed to include elements of a combinatorial optimization problem.

For example, in the method described in Non-patent Literature 1, an optimization calculation is performed to find the expression (objective function model) relating multiple 0/1 binary variables (spins) representing the arrangement of the material to the radiation intensity by using machine learning and iterating the procedure to obtain the spins that maximizes the radiation intensity by using quantum annealing. However, due to biases etc., in the training data used for this machine learning, it is assumed that the solution of the optimization calculation may fall into the local optimum solution and the arrangement of the material that gives the desired radiation intensity cannot be obtained.

To address these issues, it is considered desirable to prepare multiple sets of training data and perform the above optimal calculation for each of them. Therefore, in this example embodiment, the optimization calculation is performed multiple times by iterating the creation of the objective function model by machine learning and the solution calculation by annealing. At this time, in the nth optimization calculation, annealing is performed to avoid solutions within a predetermined range from the optimal solutions in the optimization calculations up to the n−1st optimization calculation. This reduces the possibility that the desired solution cannot be obtained due to bias in the training data.

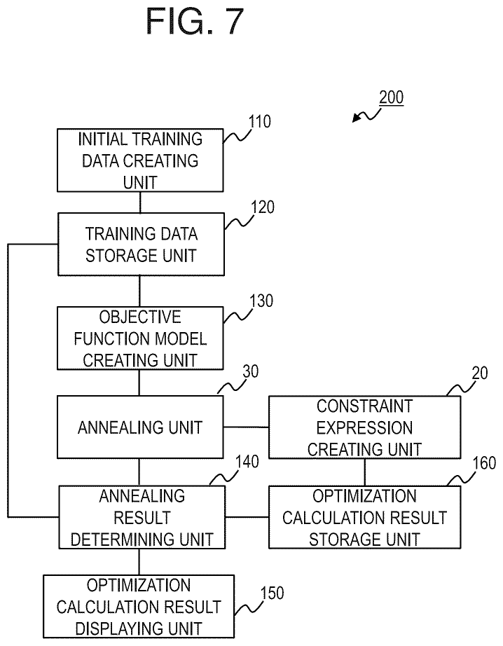

FIG. 7 is a block diagram showing a configuration example of second example embodiment of an optimization device according to this disclosure. The optimization device 200 in this example embodiment includes an initial training data creating unit 110, a training data storage unit 120, an objective function model creating unit 130, the constraint expression creating unit 20, the annealing unit 30, an annealing result determining unit 140, an optimization calculation result displaying unit 150, and an optimization calculation result storage unit 160.

That is, compared to the optimization device 100 of the first example embodiment, the optimization device 200 of this example embodiment includes the objective function model creating unit 130, the optimization calculation result displaying unit 150, and the optimization calculation result storage unit 160, instead of the objective function creating unit 10, the solution calculation result storage unit 40, and the solution calculation result displaying unit 50, and also, it differs from the first example embodiment in that it includes the initial training data creating unit 110, the training data storage unit 120, and the annealing result determining unit 140. Other configurations are similar to the first example embodiment.

The initial training data creating unit 110 creates initial training data used by the objective function model creating unit 130, which is described below, to learn an objective function model that expresses the black box function of the black box optimization problem as a spin polynomial. The objective function model corresponds to the objective function H_{O}(s) in the first example embodiment. In other words, the Hamiltonian to be annealed by the annealing unit 30 is represented as the sum of the objective function model and the constraint expressions created by the constraint expression creating unit 20.

The method by which the initial training data creating unit 110 creates the initial training data is arbitrary. The initial training data creating unit 110 may, for example, create training data in response to instructions from the user, etc., or may instruct the simulator, which is a black box function for the target black box optimization problem, to create training data.

The training data storage unit 120 stores training data used for training by the objective function model creating unit 130, which is described below. The training data storage unit 120 may store training data created by the initial training data creating unit 110, or training data created by users, other systems, etc. The training data storage unit 120 is realized by, for example, a magnetic disk.

The objective function model creating unit 130 creates an objective function model that represents the black box function of the black box optimization problem in terms of the spin polynomial. Specifically, the objective function model creating unit 130 performs a process to learn the objective function model expressed in the spin polynomial by machine learning using the training data described above. The objective function model is expressed, for example, as in Equation 6 shown below, and the parameters Qᵢⱼ, and b are derived by machine learning. In Equation 6, H_{O}(s) is the objective function model, and sᵢ and sⱼ are the spins, respectively.

$$[ Math . 6 ]$$

$${H}_{o} ( s ) = {\sum }_{i \leq j} {Q}_{ij} {s}_{i} {s}_{j} + b \qquad ( Equation 6 )$$

The method of annealing by the annealing unit 30 is the same as in the first example embodiment.

The annealing result determining unit 140 determines whether to continue the optimization process. For example, the annealing result determining unit 140 may determine that a sufficient solution has been obtained when the value of the Hamiltonian is smaller than a predetermined value, and determine that the process is completed. The criteria for determining whether to continue or not, for example, may be defined by the user, etc.

Furthermore, the annealing result determining unit 140 applies the optimal solution obtained by annealing of the annealing unit 30 to the black box function of the black box optimization problem to create new training data.

The optimization calculation result displaying unit 150 displays the results of the optimization calculations. The optimization calculation result displaying unit 150 may, for example, display the learned objective function model. Otherwise, the optimization calculation result displaying unit 150 may display a graph indicating the convergence status of the objective function. A graph indicating the convergence status of the objective function is described below.

The optimization calculation result storage unit 160 stores the results of the optimization calculations. The optimization calculation result storage unit 160 is realized by, for example, a magnetic disk.

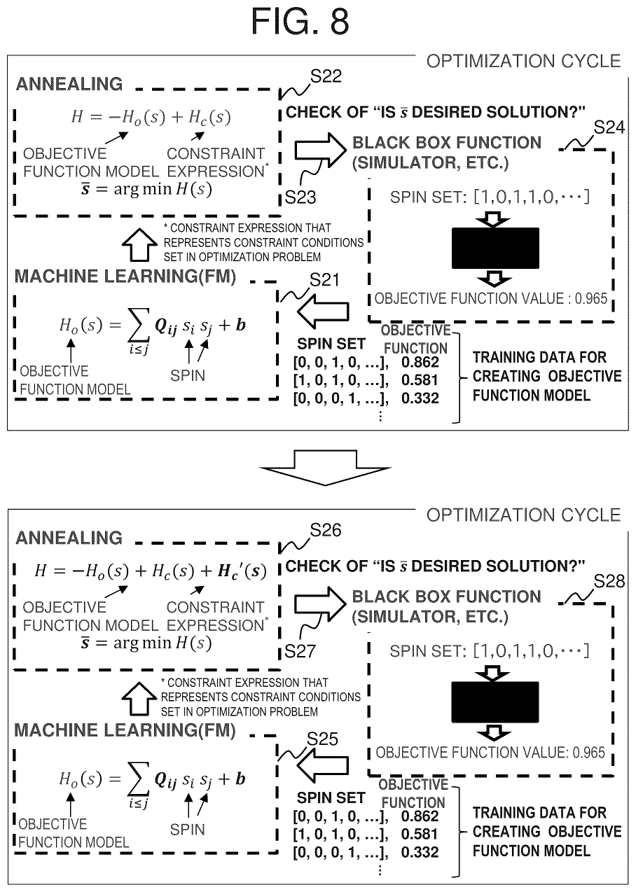

The following is a specific explanation of optimization calculations performed by the initial training data creating unit 110, the objective function model creating unit 130, the annealing result determining unit 140, and the annealing unit 30 using the training data storage unit 120. FIG. 8 is an explanatory diagram showing an example of optimization calculation.

The example shown in FIG. 8 shows the case where the first method in the first example embodiment (in other words, a method of adding a constraint expression that imposes a (positive) penalty if a spin set whose distances from spin sets indicating the optimal solutions already obtained in past solution calculations are within a predetermined range is selected) is used as annealing by the annealing unit 30.

First, the initial training data creating unit 110 creates an initial training data set and stores this in the training data storage unit 120. The objective function model creating unit 130 learns an objective function model using this training data set. For example, the objective function model creating unit 130 learns an objective function model in which the spin set is the explanatory variable and the value obtained by applying the spin set to a black box function representing a black box optimization problem is the objective variable, using the training data stored in the training data storage unit 120 (Step S21).

The annealing unit 30 creates a Hamiltonian used for annealing from the obtained objective function model and constraint expressions. For example, the Hamiltonian H is expressed as the sum of the objective function model H_{O}(s) and the constraint expression H_{C}(s), as shown in FIG. 8. Then, the annealing unit 30 executes the first solution calculation by annealing (step S22). The first solution calculation obtains a spin set “s superscript bar” that minimize the Hamiltonian H. Hereinafter, “superscript bar” is denoted by⁻: s⁻. s⁻=[s₁⁻, s₂⁻, s₃⁻, . . . , s_{Ns}⁻].

The annealing result determining unit 140 determines whether to continue the cycle of optimization (step S23). The annealing result determining unit 140 may, for example, determine whether to continue the cycle of optimization based on whether the value obtained by applying s⁻ to the black box function representing the black box optimization problem is the desired solution. If it is determined to continue the cycle of optimization, the annealing result determining unit 140 creates new training data and adds it to the training data set (step S24). For example, the annealing result determining unit 140 may apply spin set s⁻ that are explanatory variables to the simulator, which is a function representing the target black box optimization problem (black box function), and create training data with the obtained value as the objective function.

The optimization cycle from step S21 to step S24 shown above is repeated a predetermined number of times to complete the first optimization calculation. The spin set of the best solution obtained in the first optimization calculation is denoted as “s₁ superscript tilde” (hereafter, “superscript tilde” is denoted by^{˜}:s₁^{˜})=[s_{1,1}^{˜}, s_{1,2}^{˜}, s_{1,3}^{˜}, . . . , s_{1,Ns}^{˜}].

Next, the initial training data creating unit 110 creates a new training data set and stores this in the training data storage unit 120.

Next, the objective function model creating unit 130 learns an objective function model for this new training data set (step S25). The learning method in step S25 is the same as that in step S21.

Next, the annealing unit 30 creates a Hamiltonian for annealing from the obtained objective function model and constraint expressions. Then, the annealing unit 30 executes the solution calculation by annealing in the same method as the first method shown in the first example embodiment. That is, the annealing unit 30 executes the solution calculation using the Hamiltonian H added the constraint (e.g., the constraint expression shown in Equation 4 above) that penalizes the selection of a spin set whose distance from the spin set s₁^{˜} that indicates the best solution obtained in the first optimization calculation is within a predetermined range (step S26). This solution calculation gives the spin set that minimizes the Hamiltonian H.

As in step S23, the annealing result determining unit 140 determines whether to continue the cycle of optimization (step S27). If it is determined to continue the cycle of optimization, the annealing result determining unit 140 further creates new training data and adds it to the training data set (step S28), as in step S24.

The optimization cycle from step S25 to step S28 shown above is repeated a predetermined number of times to complete the second optimization calculation. The spin set of the best solution obtained in the second optimization calculation is defined as s₂^{˜}=[s_{2,1}^{˜}, s_{2,2}^{˜}, s_{2,3}^{˜}, . . . , s_{2,Ns}^{˜}].

Thereafter, the nth optimization calculation is performed in the same manner as the second optimization calculation. That is, the initial training data creating unit 110 creates a new training data set and stores it in the training data storage unit 120.

Next, the objective function model creating unit 130 learns an objective function model with this new training data set (step S25). Next, the annealing unit 30 creates a Hamiltonian for annealing from the obtained objective function model and constraint expressions. Then, the annealing unit 30 adds the constraint expression (e.g., the constraint expression shown in Equation above) to the Hamiltonian that imposes a penalty if a solution whose distances from each of the best solutions (s₁^{˜}, s₂^{˜}, . . . , sₙ₋₁^{˜}) of the optimization calculations by the n−1st time are within a predetermined range is selected, creates a Hamiltonian to be used in annealing and executes solution calculation (step S26). The solution gives the spin set that minimizes the Hamiltonian H. Here, sₙ₋₁^{˜} represents the best solution of the n−1st optimization calculation (sₙ₋₁^{˜}=[s_{n-1,1}^{˜}, s_{n-1,2}^{˜}, s_{n-1,3}^{˜}, . . . , s_{n-1,Ns}^{]}).

As in step S23, the annealing result determining unit 140 determines whether to continue the cycle of optimization (step S27). If it is determined to continue the cycle of optimization, the annealing result determining unit 140 further creates new training data and adds it to the training data set (step S28), as in step S24.

By repeating the cycle of optimization from step S25 to step S28 shown above a predetermined number of times, the nth optimization calculation is completed. sₙ^{˜}=[s_{n,1}^{˜}, s_{n,2}^{˜}, s_{n,3}^{˜}, . . . , s_{n,Ns}^{˜}] is the spin set of the best solution obtained by the nth optimization calculation.

Then, the annealing result determining unit 140 determines whether or not to perform the next optimization calculation, and if it is determined that the next optimization calculation is to be performed, the initial training data creating unit 110 further creates a new training data set (step S28). On the other hand, if it is determined that the optimization calculation is not to be continued, the process is completed. The optimization calculation result displaying unit 150 may, for example, display the objective function model as the calculation result. Otherwise, the optimization calculation result displaying unit 150 may display a graph showing the convergence status of the objective function.

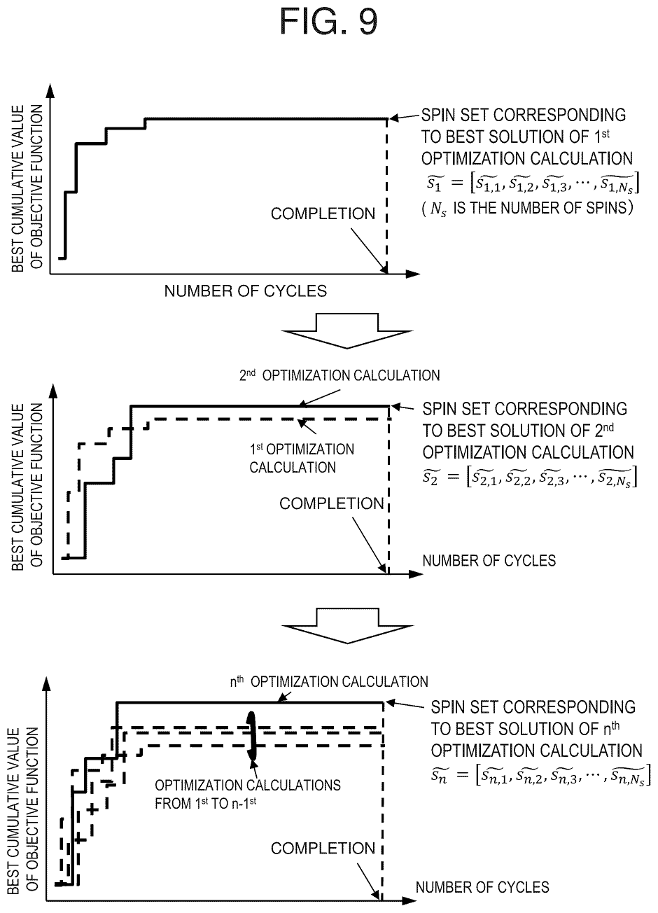

FIG. 9 is an explanatory diagram showing an example of a graph showing convergence status of an objective function. First, in the first optimization calculation, a spin set s₁^{˜} corresponding to the best solution is obtained by repeating the cycle of optimization by machine learning and annealing. Second, in the second optimization calculation, the spin set s₂^{˜} corresponding to the best solution is obtained by repeating the cycle of processing by machine learning and annealing. The spin set s₂^{˜} obtained in the second optimization calculation is different from the spin set s₁^{˜} obtained in the first optimization calculation, and the cumulative best value of the objective function can also be increased.

Furthermore, in the nth optimization calculation, a spin set sₙ^{˜} corresponding to the best solution is obtained. Considering the first to n−1st optimization calculations, the cumulative optimal value of the objective function can be further increased as a result of the nth optimization calculation. The optimization calculation result displaying unit 150 may display such a graph. In the above explanation, sₙ^{˜} represents the best solution in the nth optimization calculation, but sₙ^{˜} may be the solution most frequently obtained in the nth optimization calculation, etc.

The above example shows the case where the first method in the first example embodiment is used as annealing by the annealing unit 30. The same applies when the annealing unit 30 uses the second method in the first example embodiment. That is, during annealing, the annealing unit 30 perform the nth optimization calculation by annealing that excludes from the search range any spin set whose distances from the spin sets indicating the best solutions already obtained by the past n−1st optimization calculation are within a predetermined range.

The initial training data creating unit 110, the objective function model creating unit 130, the constraint expression creating unit 20, the annealing unit 30, the annealing result determining unit 140, and the optimization calculation result displaying unit 150 are realized by a computer processor operating according to a program (optimization program).

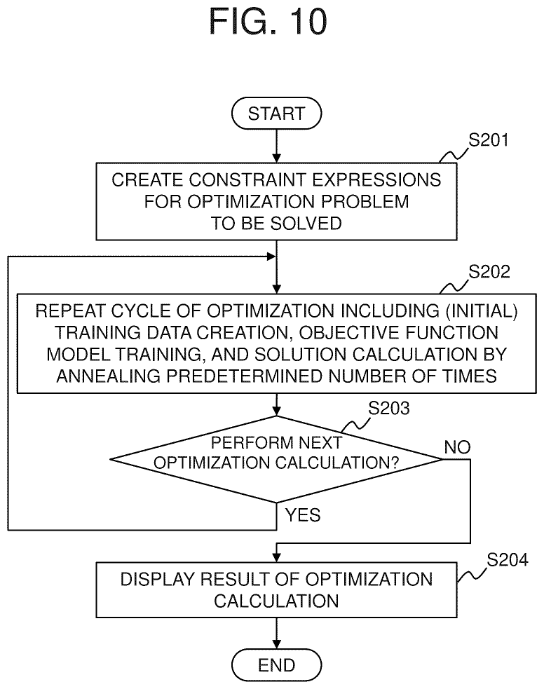

Next, the operation of the optimization device 200 of this example embodiment is described below. FIG. 10 is a flowchart showing an example of an operation of the optimization device 200 according to this disclosure.

The constraint expression creating unit 120 creates constraint expressions for the optimization problem to be solved (step S201).

The initial training data creating unit 110, the training data storage unit 120, the objective function model creating unit 130, the constraint expression creating unit 20, the annealing unit 30, annealing result determining unit 140, and the optimization calculation result storage unit 160 repeat the cycle of optimization including (initial) training data creation, objective function model training, and solution calculation by annealing a predetermined number of times. This is called optimization calculation (Step S202).

The annealing result determining unit 140 determines whether or not to perform the next optimization calculation (step S203). If it is determined that the optimization calculation is to be performed (yes in step S203), it returns to step 202 and the next optimization calculation is performed. In annealing during the nth optimization calculation, solution calculation is executed so as to exclude from search range spin sets whose distances from each spin set of best solutions obtained by the n−1st optimization calculation are within a predetermined range.

On the other hand, if it is determined that optimization calculation is not to be performed (no in step S203), the optimization calculation result displaying unit 150 displays the results of optimization calculations so far (step S204) and completes the process.

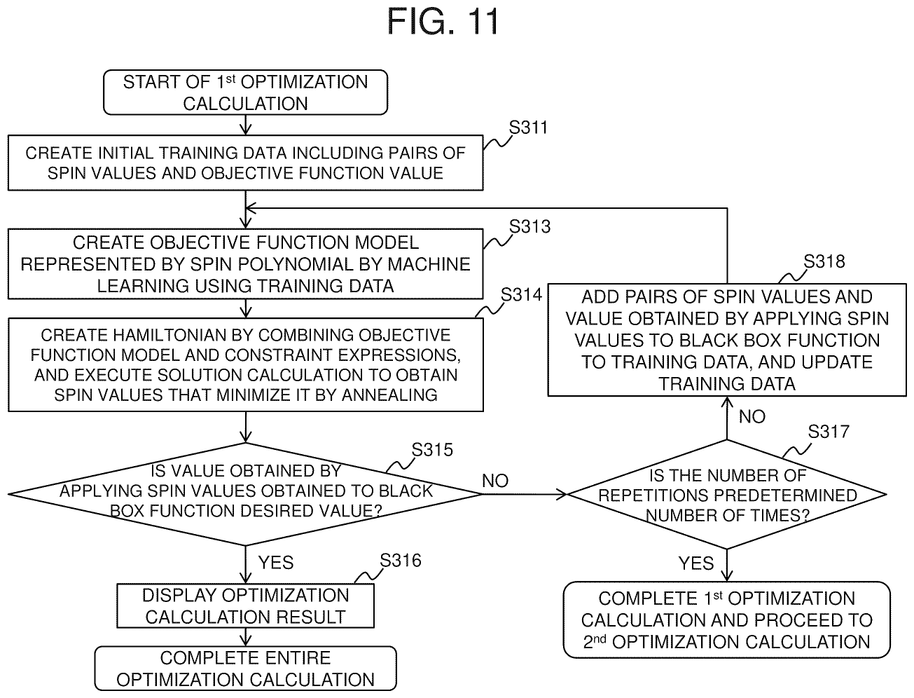

Next, the specific process of optimization calculation will be explained. FIG. 11 is a flowchart showing an example of an operation of the first optimization calculation. The initial training data creating unit 110 creates initial training data including pair of spin values and objective function value (step S311). The objective function model creating unit 130 creates an objective function model represented by a spin polynomial by machine learning using the training data (step S313).

The annealing unit 30 creates a Hamiltonian by combining the objective function model and the constraint expressions expressing constraint conditions of the optimization problem to be solved created in step S201 in terms of spin polynomial, and executes solution calculation to obtain the spin values that minimize it by annealing (step S314). The annealing result determining unit 140 determines whether the value obtained by applying the spin values obtained by annealing to the black box function is the desired value or not (Step S315). If it is a desired value (yes in step S315), the optimization calculation result displaying unit 150 displays the optimization calculation result (step S316) and completes the entire optimization calculation.

On the other hand, if it is not a desired value (no in step S315), the annealing result determining unit 140 determines whether the number of repetitions (more specifically, the number of processing steps S313 to S315 and step S318, which is the number of optimization cycles) is a predetermined number of times (step S317). If it is the predetermined number of times (yes in step S317), the first optimization calculation is completed and the second optimization calculation is performed.

On the other hand, if the number of times is not a predetermined number (no in step S317), the annealing unit 30 adds pairs of the spin values obtained in step S314 and the values obtained in step S315 by applying the spin values to the black box function to the training data, and updates the training data (step S318). Thereafter, the process from step S313 onward is repeated.

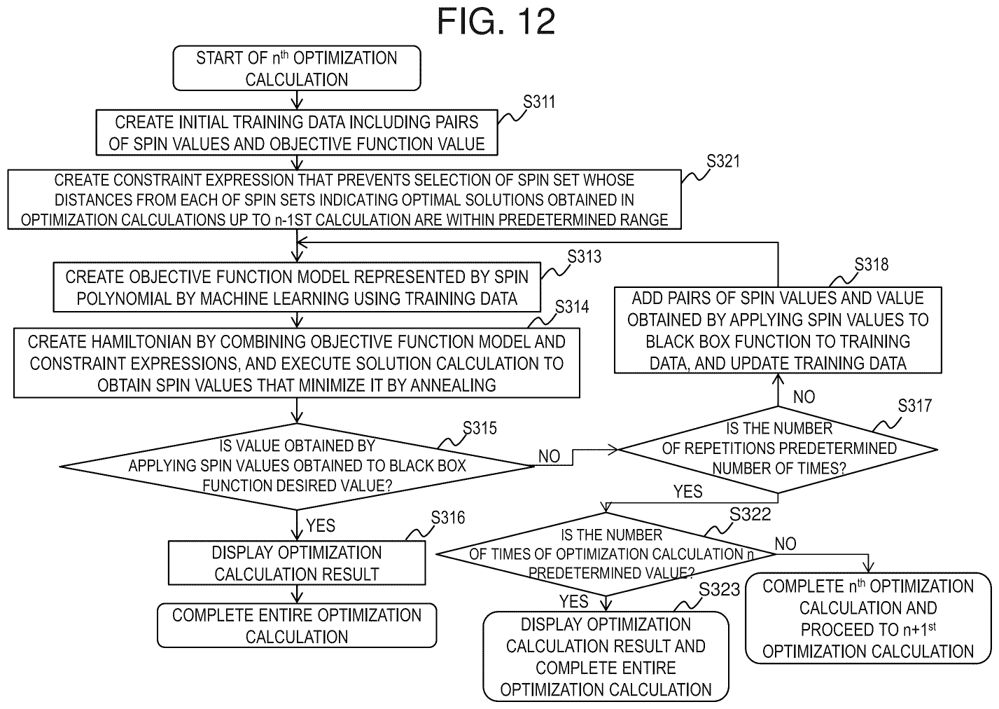

Next, the specific process for the second and subsequent (nth) optimization calculations will be explained. FIG. 12 is a flowchart showing an example of an operation of the nth optimization calculation. The flowchart shown in FIG. 12 shows an example of the operation in which the first method of executing the solution calculation in the first example embodiment is used as solution calculation method. The process of creating the initial training data is similar to the process of step S311 shown in FIG. 11.

The constraint expression creating unit 20 creates a constraint expression that prevents the selection of a spin set whose distances from each of the spin sets indicating the optimal solutions obtained in up to the n−1st optimization calculations are within a predetermined range (step S321). Thereafter, the process from the execution of the solution calculation by annealing to when the optimization calculation is completed is the same as the process from step S313 to step S318 in FIG. 11.

Here, if the number of times of iterations from S318 to S315 is predetermined value in step S317 (yes in step S317), the annealing result determining unit 140 further determines whether the number of times of optimization calculation is predetermined value (step S322). If it is the predetermined number of times (yes in step S322), the optimization calculation result displaying unit 150 displays the optimization calculation result and completes the entire optimization calculation (step S323). On the other hand, if it is not the predetermined number of times (no in step S322), the nth optimization calculation is completed and the n+1st optimization calculation is performed.

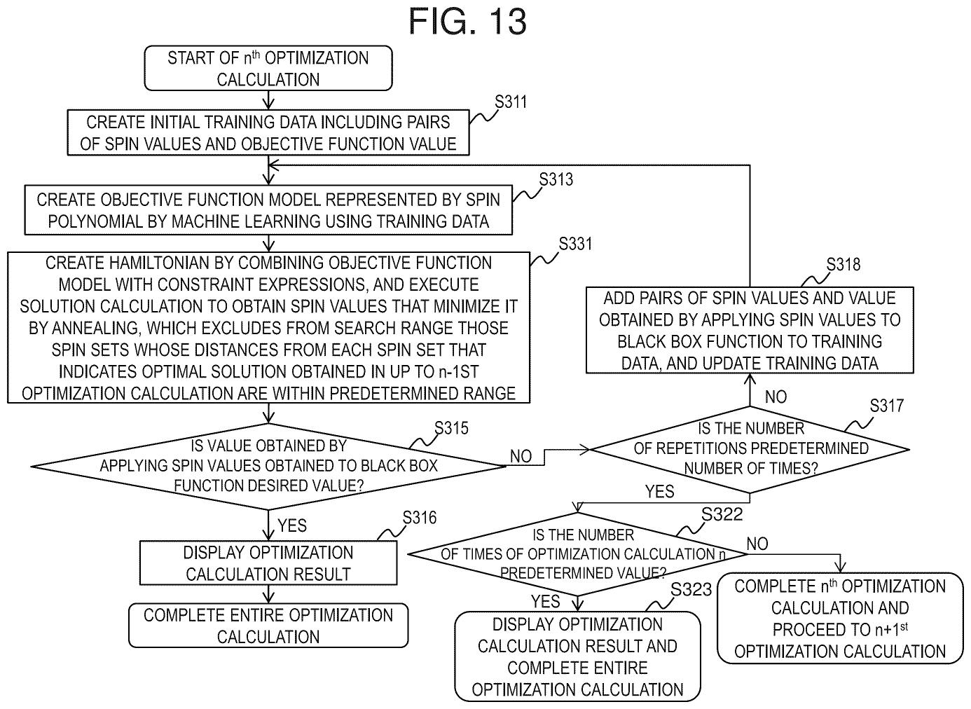

FIG. 13 is a flowchart showing another example of an operation of the nth optimization calculation. The flowchart shown in FIG. 13 shows an example of the operation of the second method of performing the solution calculation in the first example embodiment. The process up to creating the initial training data and creating the objective function model is similar to the process of steps S311 and S313 shown in FIG. 11.

The annealing unit 30 creates a Hamiltonian by combining the objective function model and the constraint expressions. Then, the annealing unit 30 execute solution calculation to obtain the spin values that minimize it by annealing, which excludes from the search range those spin sets whose distances from each spin set that indicates the optimal solution obtained in up to the n−1st optimization calculation are within a predetermined range (step S331). Thereafter, the process until the optimization results are displayed is the same as the process from step S315 onward as shown in FIG. 12.

In this example, the possibility of not obtaining the desired solution is suppressed by preventing the best solutions in the optimization calculations up to the n−1st optimization calculation from being selected in the annealing within the nth optimization calculation. However, the same operation may be performed in the optimization cycle within each optimization calculation. In other words, the operation is to suppress the possibility that the desired solution will not be obtained by preventing the optimal solutions up to the n−1st optimization cycle from being selected during the annealing in the nth optimization cycle.

As described above, in this example embodiment, the objective function model creating unit 130 learns an objective function model expressed by a spin polynomial by machine learning, and the annealing unit 30 executes the solution calculation by the annealing using an objective function that includes the objective function model. In the annealing of nth optimization calculation, the spin sets whose distances from spin sets of best solutions obtained up to n−1st optimization calculation are within a predetermined range are excluded from search range. Therefore, the possibility that a desired solution cannot be obtained due to bias in the training data in black box optimization can be suppressed, and a more favorable solution can be obtained.

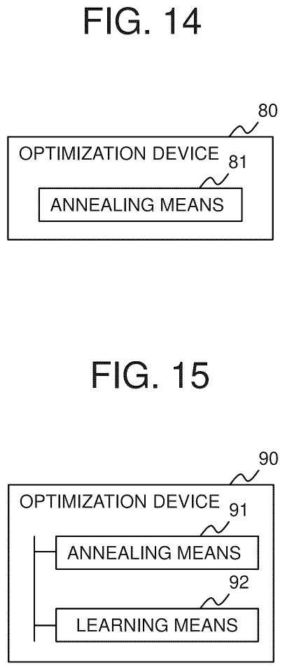

Next, an overview of the present disclosure will be described. FIG. 14 is a block diagram showing an outline of the optimization device according to this disclosure. The optimization device 80 according to this disclosure is an optimization device that solves a combinatorial optimization problem by annealing (e.g., the optimization device 100), and includes an annealing means 81 (e.g., the annealing unit 30) that executes solution calculation by annealing multiple times.

The annealing means 81 executes solution calculation so as to exclude from search range spin sets whose distances (e.g., Hamming distance, Euclidean distance, etc.) from spin sets indicating optimal solutions obtained by the n−1st solution calculation are within a predetermined range in the nth optimization calculation (specifically, n≥2).

Such a configuration allows stepwise optimal solutions to be obtained in optimization using annealing.

The optimization device 80 may include an output means (e.g., the solution calculation result displaying unit 50) which outputs the optimal solutions obtained by multiple times of solution calculation in the order in which the optimal solutions are obtained.

The annealing means 81 may also executes the nth solution calculation using a Hamiltonian with an additional constraint expression that gives a penalty if a spin set whose distances from the spin sets indicating the optimal solutions already obtained by the past n−1st solution calculation are within a predetermined range is selected (e.g., by the first method described above).

FIG. 15 is a block diagram showing another outline of the optimization device according to this disclosure. The optimization device 90 according to this disclosure is an optimization device (e.g., the optimization device 200) that solves a combinatorial optimization problem by annealing, and includes an annealing means 91 (e.g., the annealing unit 30) which executes solution calculation by annealing multiple times, and a learning means 92 (e.g., the objective function model creating unit 130) which learns an objective function model expressed by a spin polynomial by machine learning using training data which includes pairs of a spin set as an explanatory variable and a value obtained by applying the spin set to a black box function representing a black box optimization problem as an objective variable.

The annealing means 91 executes the solution calculation by the annealing using a Hamiltonian including the objective function model, and executes multiple optimization calculations in which learning of the objective function model and the solution calculation by the annealing are repeated. Also, the annealing means 91 executes solution calculation by the annealing so as to exclude from search range spin sets whose distances from spin sets indicating best solutions obtained by the n−1st optimization calculation are within a predetermined range in the nth optimization calculation.

With such a configuration, the possibility that a desired solution cannot be obtained due to bias in the training data in black box optimization can be suppressed, and a more favorable solution can be obtained.

The learning means 92 may also create new training data by applying the solution obtained by annealing to the black box function, and learn an objective function model by machine learning using the created training data.

Also, the annealing means 91 may execute solution calculation using a Hamiltonian with an additional constraint expression that gives a penalty if, in the nth optimization calculation, a spin set whose distances from the spin sets indicating the best solutions obtained by the n−1st optimization calculation are within a predetermined range is selected.

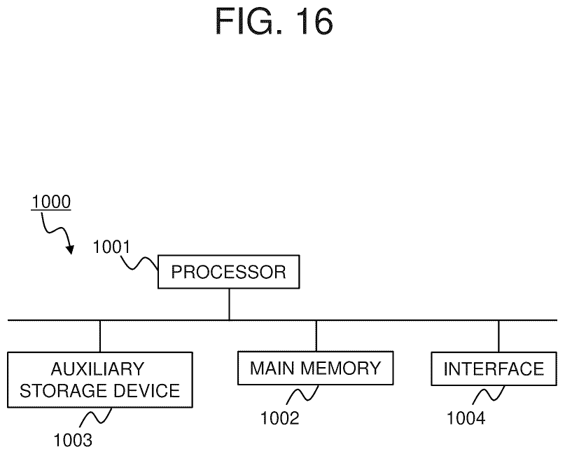

FIG. 16 is a schematic block diagram showing a configuration of a computer according to at least one example embodiment. A computer 1000 includes a processor 1001, a main memory 1002, an auxiliary storage 1003, and an interface 1004. A computer which executes a mathematical programming solver, an annealing machine, simulator, etc. may be connected to the computer 1000.

The optimization device 80 described above is implemented in the computer 1000. The operations of each processing unit described above are stored in the auxiliary storage 1003 in the form of a program (optimization program). The processor 1001 reads the program from the auxiliary storage 1003, expands it in the main memory 1002, and executes the above processing according to the program.

In at least one example embodiment, the auxiliary storage 1003 is an example of a non-temporary tangible medium. Other examples of non-transient tangible media include magnetic disks connected via the interface 1004, magneto-optical disks, CD-ROM (Compact Disc Read-only memory), DVD-ROM (Read-only memory), semiconductor memory, etc., connected via the interface 1004. When the program is delivered to the computer 1000 via a communication line, the computer 1000 receiving the delivery may expand the program into the main memory 1002 and execute the above process.

The program may also be a program to realize some of the features mentioned above. Furthermore, the program may be a so-called difference file (difference program), which realizes the features mentioned above in combination with other programs already stored in the auxiliary storage 1003.

Although the disclosure has been described above with reference to the example embodiments, the disclosure is not limited to the example embodiments described above. Various changes can be made to the configuration and details of the disclosure that can be understood by those skilled in the art within the scope of this disclosure. And each example embodiment can be combined with other example embodiments as appropriate.

1. An optimization device that solves a combinatorial optimization problem by annealing comprising:
a memory storing instructions; and
one or more processors configured to execute the instructions to execute solution calculation by annealing multiple times so as to exclude from search range spin sets whose distances from the spin sets indicating optimal solutions obtained by the n−1st solution calculation are within a predetermined range in the nth solution calculation.

2. The optimization device according to claim 1, wherein the processor is configured to execute the instructions to output the optimal solutions obtained by multiple times of solution calculation in the order in which the optimal solutions are obtained.

3. The optimization device according to claim 1, wherein the processor is configured to execute the instructions to execute the nth solution calculation using a Hamiltonian with an additional constraint expression that gives a penalty if a spin set whose distances from the spin sets indicating the optimal solutions already obtained by the past n−1st solution calculation are within a predetermined range is selected.

4. An optimization device that solves a combinatorial optimization problem by annealing comprising:
a memory storing instructions; and
one or more processors configured to execute the instructions to execute:
learn an objective function model expressed by a spin polynomial by machine learning using training data which includes pairs of a spin set as an explanatory variable and a value obtained by applying the spin set to a black box function representing a black box optimization problem as an objective variable;
execute the solution calculation by the annealing using a Hamiltonian including the objective function model, and execute multiple optimization calculations in which learning of the objective function model and the solution calculation by the annealing are repeated; and
execute solution calculation by the annealing so as to exclude from search range spin sets whose distances from spin sets indicating best solutions obtained by the n−1st optimization calculation are within a predetermined range in the nth optimization calculation.

5. The optimization device according to claim 4, wherein the processor is configured to execute the instructions to create new training data by applying the solution obtained by annealing to the black box function, and learn an objective function model by machine learning using the created training data.

6. The optimization device according to claim 4, wherein the processor is configured to execute the instructions to execute solution calculation using a Hamiltonian with an additional constraint expression that gives a penalty if, in the nth optimization calculation, a spin set whose distances from the spin sets indicating the best solutions obtained by the n−1st optimization calculation are within a predetermined range is selected.

7. An optimization method that solves a combinatorial optimization problem by annealing comprising executing solution calculation by annealing multiple times, wherein
in the annealing, executing solution calculation so as to exclude from search range spin sets whose distances from the spin sets indicating optimal solutions obtained by the n−1st solution calculation are within a predetermined range in the nth solution calculation.

8. An optimization method that solves a combinatorial optimization problem by annealing comprising:
learning an objective function model expressed by a spin polynomial by machine learning using training data which includes pairs of a spin set as an explanatory variable and a value obtained by applying the spin set to a black box function representing a black box optimization problem as an objective variable;
executing solution calculation by the annealing using the objective function including the objective function model;
executing multiple optimization calculations in which learning of the objective function model and the solution calculation by the annealing are repeated; and
executing solution calculation by the annealing so as to exclude from search range spin sets whose distances from spin sets indicating best solutions obtained by the n−1st optimization calculation are within a predetermined range in the nth optimization calculation.

9. A non-transitory computer readable information recording medium storing an optimization program applied to a computer that solves a combinatorial optimization problem by annealing, when executed by a processor, that performs a method for executing solution calculation by annealing multiple times so as to exclude from search range spin sets whose distances from the spin sets indicating optimal solutions obtained by the n−1st solution calculation are within a predetermined range in the nth solution calculation, in the annealing process.

10. A non-transitory computer readable information recording medium storing an optimization program applied to a computer that solves a combinatorial optimization problem by annealing, when executed by a processor, that performs a method for:
learning an objective function model expressed by a spin polynomial by machine learning using training data which includes pairs of a spin set as an explanatory variable and a value obtained by applying the spin set to a black box function representing a black box optimization problem as an objective variable;
executing the solution calculation by the annealing using an objective function including the objective function model, and executing multiple optimization calculations in which learning of the objective function model and the solution calculation by the annealing are repeated; and
executing solution calculation by the annealing so as to exclude from search range spin sets whose distances from spin sets indicating best solutions obtained by the n−1st optimization calculation are within a predetermined range in the nth optimization calculation, in the annealing process.
